(19) United States
(12) Patent Application Publication
(10) Pub. No.: US 2002/0149850 A1
(43) Pub. Date: Oct. 17, 2002

(54) Tunable optical filter

(75) Inventors: Brian Lee Heffner, San Jose, CA (US); Gokul Krishnan, San Jose, CA (US)

Correspondence Address: Hall, Priddy, Myers & Vande Sande, Suite 200, 10220 River Road, Potomac, MD, 20854, US

(73) Assignee: E-Tek Dynamics, Inc.

(21) Appl. No.: 09/835,338

(22) Filed: Apr. 17, 2001

(51) Int. Cl. G02B 27/00

(52) U.S. Cl. 359/578; 359/577

(57) ABSTRACT

A tunable optical notch filter employing a Fabry-Perot etalon has a first partially reflective mirror and a second mirror with variable effective reflectivity. Both the gap of the etalon and the effective reflectivity of the second mirror can be controlled, e.g. by TAB actuators, enabling a control of the central wavelength and the depth (loss) of the notch of the spectral response of the filter.

### FIELD OF THE INVENTION

This invention relates to tunable optical filters and more specifically, to tunable optical notch filters employing a Fabry-Perot cavity.

### BACKGROUND OF THE INVENTION

Tunable optical filters utilizing an etalon with two partially reflective mirrors forming a gap therebetween, the etalon known also as Fabry-Perot etalon, are known in several forms. By adjusting the gap of the etalon, whether formed by two coated fiber faces or by partly reflective mirrors, optionally in a MEMS (microelectromechanical system) environment, the central wavelength of the spectral response of the filter can be tuned.

An etalon filter is a bandpass filter that provides a reflective filter response in which all wavelengths are reflected except those near the filter resonance. The spectral characteristics of an etalon filter are generally determined, according to the present knowledge, by the (fixed) reflectivity and gap spacing (cavity length) of the mirror surfaces. Tuning of the central wavelength of the spectral passband of the etalon is achieved by varying the effective cavity length of the device. The effective cavity length may be varied by altering the actual physical gap size, or the refractive index of the gap medium, or both. The tuning mechanism may include piezoelectric actuators, liquid crystals, temperature, pressure or other mechanisms. Known are also tunable filters operable to adjust both the wavelength and the depth (amplitude) of the transmission notch of the spectral response. For example, lithium niobate waveguide devices use a surface acoustic wave to couple energy from one polarization to the other over a limited optical bandwidth. The wavelength and depth of the notch is controlled by the frequency and power of the acoustic wave. These devices require polarization diversity techniques, and typically have a loss of several dB. Multiple notches can be created by using acoustic waves at multiple frequencies, but the notches cannot overlap because light in the overlap region is amplitude-modulated at the acoustic frequency.

All-fiber devices have been demonstrated in which a transverse acoustic wave couples light from the core to cladding modes. By coupling to different cladding modes, two or three notches can be overlapped without interference. However, the all-fiber device also requires polarization diversity techniques, leading to a loss of at least 1 to 2 dB.

U.S. Pat. Nos. 5,500,761 and 6,002,513 issued to Goossen et al. disclose a mechanical anti-reflection switch (MARS) modulator capable of providing independent control of attenuation and spectral tilt.

The MARS modulators are variable Fabry-Perot cavities comprising a silicon substrate and a membrane made of multiple layers of silicon nitride and polycrystalline silicon.

Other etalon-based tunable optical filters are described e.g. in U.S. Pat. Nos. 5,283,845 to Ip and 5,666,225 to Colbourne.

Thermal arched beam (TAB) actuators have recently been developed and are described e.g. in U.S. Pat. No. 5,909,078 (Wood et al.) and U.S. Pat. No. 5,994,816 (Dhuler et al.). The two specifications are hereby incorporated herein by reference.

### SUMMARY OF THE INVENTION

It is proposed to provide a simple tunable optical filter capable of tuning both the notch wavelength and the depth of the notch of the spectral response of the filter. In accordance with the invention, this object is achieved by a filter in which both the etalon gap and the effective reflectivity of at least one of the reflective or partly reflective surfaces (mirrors) are adjustable. Thus, in accordance with the invention, there is provided a tunable optical filter comprising:

a Fabry-Perot cavity defined by a first partial reflector and a second reflector facing the first reflector, the first and second reflectors mounted in a spaced-apart relationship to form a gap therebetween,

an input port optically coupled to said cavity for feeding an input light beam into said cavity in a manner to produce a filtered light beam,

an output port for porting out a light beam that has been reflected from the second reflector and has passed through the cavity,

first control means for varying the gap, and

second control means for varying effective reflectivity of the second reflector.

The second reflector may have a surface of varying reflectivity at different locations of the surface. The reflectivity-varying means may be means for displacing the second surface, having variable reflectivity, laterally relative to the first surface and wherein the second surface has variable reflectivity. Alternatively, the second control means may be means for varying the relative angular position of the first surface and the second surface. Generally, the second reflector has an effective reflectivity that can be varied, either by changing its lateral position relative to the optical beam, or by tilting the second reflector.

The surface of the second reflector may comprise a diffractive grating.

The filter may comprise actuators as means for varying gap and the effective reflectivity of the second reflector. The actuators may for example be TAB (thermal arched beam) actuators, operable either singly or coupled in tandem. Other actuators, e.g. comb drives, may also be employed.

### BRIEF DESCRIPTION OF THE DRAWINGS

In the drawings,

FIG. 1 represents an exemplary spectral response of the filter of the invention,

FIG. 2 is a graph illustrating dynamic gain modeling using two filters of the invention,

FIG. 3 is a schematic top view of an embodiment of the invention, with two coupled actuators,

FIG. 4 is a schematic view of another embodiment of the invention, and

FIG. 5 is a schematic view of an embodiment with a single input/output port.

### DETAILED DESCRIPTION OF EMBODIMENTS OF THE INVENTION

Turning first to FIG. 3, an exemplary tunable optical filter of the invention is illustrated. Two lensed fiber ends 10 and 12 are disposed on a silicon substrate 13 on the left hand side of a glass chip (plate) 14 that has an anti-reflective coating 16 on the left side and a gold coating 18 on the other side. The gold coating has a reflectivity of 94% (R=0.94).

A variable-reflectivity mirror 20 is disposed adjacent to the other (right-hand) side of the glass plate 14. The mirror is mechanically connected to two thermal arched beam (TAB) actuators 22, 24 that are known in the art e.g. from Wood et al. U.S. Pat. No. 5,909,078 (titled “Thermal Arched Beam Micromechanical Actuators”). The mirror 20 has a reflective surface 26 facing the rear wall of the glass plate 14.

The reflectivity of the surface 26 in the embodiments described herein is variable and position-dependent. There are several ways of achieving the variability. One exemplary approach is to deposit a gold coating on the surface 26 through a shadow mask designed to yield a coating of variable thickness and thus reflectivity. Another approach is to provide, e.g. by etching, a grating across the mirror surface. The depth of the grating can range from zero at one side of the mirror surface 26 to e.g. a quarter-wavelength on the other side (in the direction of displacement relative to the glass plate 14). Still another approach is to provide a curved surface 26 of the mirror 20, the curvature such that light is reflected more strongly from a region of the curvature that is roughly parallel to the glass plate 14, and less strongly from a region that is more steeply sloped relative to the plate 14.

It is the third approach that is illustrated in FIG. 3. It will be recognized, however, that the latter design likely gives rise to cross-coupling between the reflectivity of the surface 26 and the gap between surface 26 and the gold coating 18.

The TAB actuators 22, 24 in FIG. 3 are coupled in tandem such that they can be activated either separately or together. The operation of actuator 22 only will result in a change of the gap and the resulting change of the central wavelength of the spectral response of the filter. The operation of actuator 24 will result in a lateral displacement of the surface 26 relative to the plate 14, exposing a different area of the surface 26, with different reflectivity, to the optical beam launched from the input fiber 10, and a resulting change of the depth of the notch of the spectral response. A combined operation of the actuators allows control of both the depth of the notch and its central wavelength, and can overcome the cross-coupling effect referred to above.

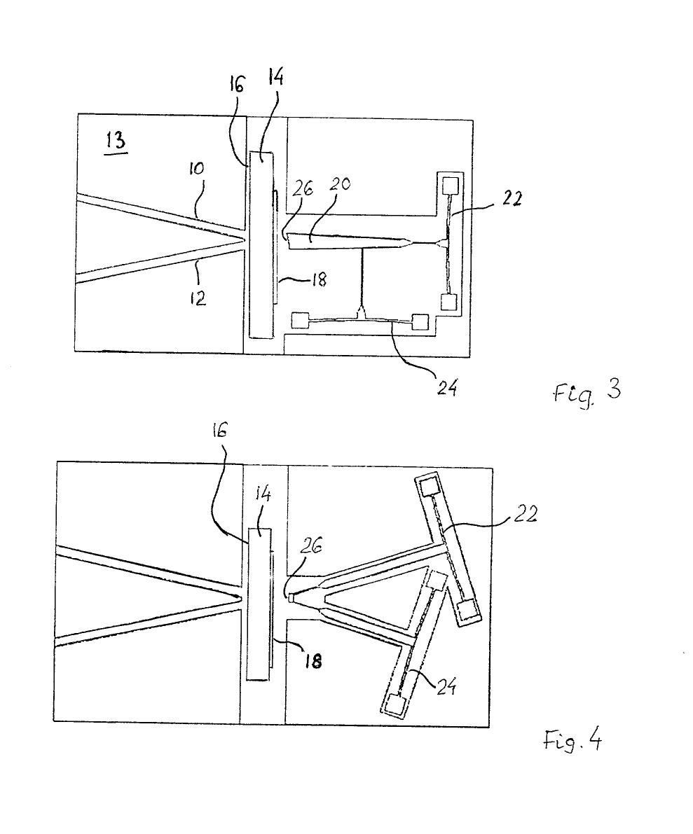

The embodiment of FIG. 4 differs from that of FIG. 3 by an arrangement of the actuators and by the shape of the reflective surface 26. It will be seen that the simultaneous and uniform operation of both actuators in the embodiment of FIG. 3 will result in a change of the gap only, while a non-symmetrical operation of the actuators will result in an angular change of the mirror 20. Since the mirror in this embodiment is flat, it can be wet-etched to produce, desirably, a relatively high reflectivity. A flat mirror can be wet-etched, because the etch process stops along a crystallographic plane. It is also feasible to fabricate a mirror separately and then solder the mirror onto the substrate. Subject to the type of the reflective surface 26, the effective reflectivity of the mirror 20 will change in response to an angular shift, resulting in a corresponding change of the depth of the amplitude notch of the spectral response.

The gold coating 18 and the surface 26 form a Fabry-Perot-type cavity of the filter of the invention. It should be recognized that, because of diffraction and accumulated wavefront tilt, none of the embodiments described herein yield simple Fabry-Perot filters, and the precision of the spectral response is somewhat compromised by the very structure of the filter of the invention. Nonetheless, the filter serves its purpose at a reasonably low finesse required.

In a specific example of the filter of the invention, the front reflector 18 was selected with power reflectivity R=0.94, the rear reflector 26 was adjusted, by tilting, for effective reflectivity R_{eff} of 0.94, 0.85, 0.64 and 0.04, with an air gap of 6.3 μm between the reflectors Sub-micron changes in the gap are known to tune the central frequency of the resonance, while larger changes will change the width of the resonance (notch).

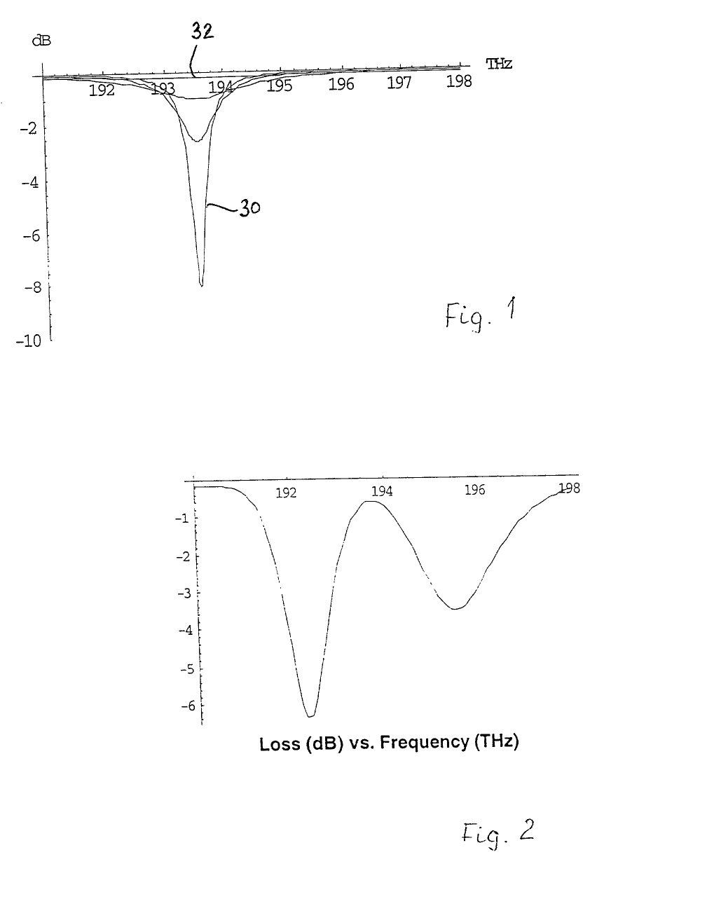

FIG. 1 illustrates the spectral response of the above exemplary filter of the invention, the lowest curve 30 corresponding to the highest reflectivity (94%) of the rear reflector and the top line 32 corresponding to the lowest reflectivity (4%) of the rear reflector.

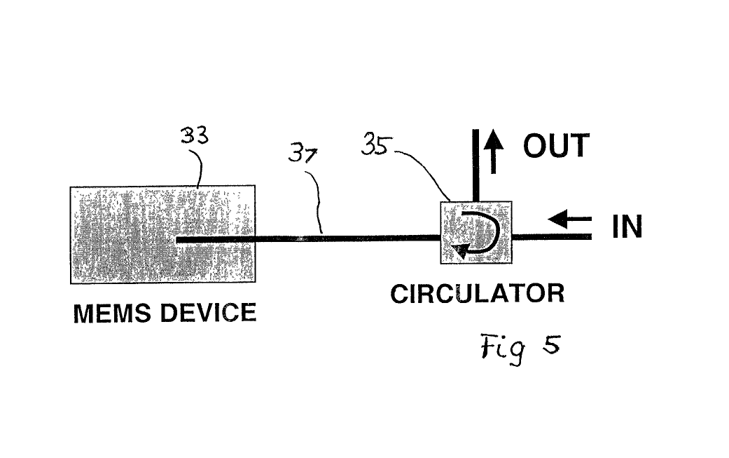

FIG. 2 illustrates the gain-modeling, or gain flattening, capability of the filter of the invention. The spectral response shown in FIG. 2 is the result of cascading two filters of the invention, with their corresponding notches shifted relative to each other. As shown in FIG. 5, the device may have a single input/output port by installing a circulator 35 on an input/output waveguide coupled to the filter 33, the single waveguide replacing, and being equivalent to, the input and output waveguides 10 and 12.

Two or more optical filters of the invention can be coupled together to produce a device for dynamic gain adjustment, including gain equalizing (flattening).

Numerous other embodiments of the invention will easily occur to those versed in the art and the invention is not intended to be limited to the embodiments described and illustrated herein.

1. A tunable optical filter comprising:
a Fabry-Perot cavity defined by a first partial reflector and a second reflector facing the first reflector, the first and second reflectors mounted in a spaced-apart relationship to form a gap therebetween,
an input port optically coupled to said cavity for feeding an input light beam into said cavity in a manner to produce a filtered light beam,
an output port for porting out a light beam that has been reflected from the second reflector and has passed through the cavity,
first control means for varying the gap, and
second control means for varying effective reflectivity of the second reflector.

2. The optical filter of claim 1 wherein said second reflector has a surface of varying reflectivity.

3. The optical filter of FIG. 1 wherein the second control means is a means for varying relative angular position of the first surface and the second surface.

4. The optical filter of claim 2 wherein said second control means is a means for displacing the second surface laterally relative to the first surface.

5. The optical filter of claim 2 wherein the surface of the second reflector comprises a diffractive grating.

6. The optical filter of claim 1 wherein said first control means comprises a TAB actuator.

7. The optical filter of claim 1 wherein said second control means comprises a TAB actuator.

8. The filter of claim 1 wherein said first and second control means are TAB actuators connected in tandem to simultaneously vary the gap and the effective reflectivity of the second reflector.

9. The filter of claim 1 wherein at least one of the first and second control means is a comb drive.

10. A device for dynamic gain adjustment or equalizing comprising two or more optical filters of claim 1.

11. A method for tuning spectral response of a filter having a Fabry-Perot cavity defining a gap between two mirrors, the method comprising the steps:
a) varying the gap and
b) varying an effective reflectivity of one of the mirrors.

12. The method of claim 11 wherein the steps a) and b) are effected in combination.

13. The method of claim 11 wherein the steps a) and b) are effected separately.
